(19) United States
(12) Patent Application Publication
(10) Pub. No.: US 2006/0265604 A1
(43) Pub. Date: Nov. 23, 2006

(54) Method and device for encryption/decryption

(75) Inventors: Gerd Dirscherl, Munchen (DE); Berndt Gammel, Markt Schwaben (DE); Rainer Goettfert, Taufkirchen (DE); Steffen Sonnekalb, Taufkirchen (DE)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(73) Assignee: Infineon Technologies AG, Munchen (DE)

(21) Appl. No.: 11/396,189

(22) Filed: Mar. 30, 2006

Related U.S. Application Data
(63) Continuation of application No. PCT/EP04/08534, filed on Jul. 29, 2004.

(30) Foreign Application Priority Data
Sep. 30, 2003 (DE) DE103 45 378.4-11

(51) Int. Cl. G06F 12/14

(52) U.S. Cl. 713/193

(57) ABSTRACT

An encryption unit and decryption unit located in an encryption/decryption device may be used both for encryption and decryption, without their effects canceling each other out when, between the decryption input of the decrypter and the encryption output of the encrypter. An encryption combiner maps the encryption result data block at the encryption output to a mapped encryption result data block according to an encryption combining mapping and is exemplarily used when encrypting. A decryption combiner maps the encryption result data block at the encryption output to an inversely mapped encryption result data block according to a decryption combining mapping which is inverse to the encryption combining mapping and is exemplarily used when decrypting.

### CROSS-REFERENCE TO RELATED APPLICATION

This application is a continuation of copending International Application No. PCT/EP2004/008534, filed Jul. 29, 2004, which designated the United States and was not published in English, and is incorporated herein by reference in its entirety.

### BACKGROUND OF THE INVENTION

1. Field of the Invention

The present invention generally refers to an encryption/decryption scheme, as may exemplarily be applied for protecting memory contents against unauthorized readout.

2. Description of Related Art

When storing data in a way protected against unauthorized spying-out, the data to be stored are not stored in clear text, i.e. in an unencrypted form, but in an encrypted form, as a so-called cipher text. When the data are to be read at a later point in time, they must consequently be decrypted again before they can be processed. Examples of applications where this complexity when storing pays off are varied and exemplarily include chip cards, smart cards or magnetic cards where information to be protected, such as, for example, amounts of money, keys, account numbers, etc., are to be protected against unauthorized access. FIG. 5 illustrates these circumstances. Data to be protected are stored in an encrypted form, which in FIG. 5 is referred to as cipher domain, in order for them not to be open to potential attackers. Outside the cipher domain, the data to be protected are in clear text, which in FIG. 5 is referred to as clear text domain. A boundary between the clear text and cipher domains in FIG. 5 is indicated by a dot-dash line. An interface between the clear text and cipher domains forms an encryption/decryption device 900. The encryption/decryption device 900 serves to encrypt unencrypted data to be stored from the clear text domain and to output same in an encrypted form for storage to the cipher domain, and conversely when calling or reading out this data to decrypt the data to be read out present in an encrypted form to output same in clear text to the clear text domain. The underlying encryption scheme is a symmetrical encryption, i.e. one where the inverse encryption, i.e. decryption, may be performed with about the same complexity as encryption. The encryption/decryption device 900 thus consists of two parts equal with regard to their size or their implementation, i.e. an encryption unit or encryption part 902 and a decryption unit or decryption part 904. The encryption unit 902 maps data at an encryption input thereof block by block to encrypted data according to a predetermined encryption algorithm and outputs same at an encryption output thereof. In the device 900, the encryption unit 902 is provided such that it receives data blocks to be stored B₁, . . . , B_{N}, wherein Nε|N, which are present in clear test, at its encryption input so that the encryption unit 902 will output encrypted data blocks C₁, . . . , C_{N}, the so-called cipher text, at an encryption output. The decryption unit 904 is responsible for the reverse direction, namely not for storing the data but for reading out the data from the memory in the cipher domain to the clear text domain. Correspondingly, the decryption unit 904 is formed to map data at its decryption unit to decrypted data according to a decryption algorithm which is inverse to the encryption algorithm of the encryption unit 902, and to output the decrypted data at a decryption output thereof. In device 900, the decryption unit 904 is provided such that it receives at a data input data blocks C₁, . . . , C_{N} stored in an encrypted form to be read out, decrypts this cipher text C₁, . . . , C_{N} block by block and outputs at the decryption output the data blocks B₁, . . . , B_{N} in clear text to the clear text domain.

It is of disadvantage in the procedure described referring to FIG. 5, i.e. of providing separate hardware for decryption and encryption, that one respective part is idle when encryption or decryption is performed. The effectiveness of such an encryption/decryption device is low in that there is a poor ratio of safety on the one hand and chip area on the other hand.

### SUMMARY OF THE INVENTION

The present invention provides an encryption/decryption scheme which is more effective than conventional schemes.

In accordance with a first aspect, the present invention provides a device for encrypting a data block to be encrypted to an encrypted data block and for decrypting a data block to be decrypted to a decrypted data block. The device has an encrypter having an encryption input and an encryption output for mapping a data block at the encryption input to an encryption result data block at the encryption output according to an encryption mapping; a decrypter having a decryption input and a decryption output for mapping a data block at the decryption input to a decryption result data block at the decryption output according to a decryption mapping which is inverse to the encryption mapping; an encryption combiner for mapping the encryption result data block to a mapped encryption result data block according to an encryption combining mapping and supplying the mapped encryption result data block to the decryption input of the decrypter; a decryption combiner for mapping the encryption result data block to an inversely mapped encryption result data block according to a decryption combining mapping to which the encryption combining mapping is which is inverse and supplying the inversely mapped encryption result data block to the decryption input of the decrypter; and a controller formed to cause the data block to be encrypted to pass the sequence of encrypter, encryption combiner and decrypter at least once to obtain the encrypted data block and the data block to be decrypted to pass the sequence of encrypter, decryption combiner and decrypter at least once to obtain the decrypted data block.

In accordance with a second aspect, the present invention provides a device for encrypting a data block to be encrypted to an encrypted data block. The device has an encrypter having an encryption input and an encryption output for mapping a data block at the encryption input to an encryption result data block at the encryption output according to an encryption mapping; a decrypter having a decryption input and a decryption output for mapping a data block at the decryption input to a decryption result data block at the decryption output according to a decryption mapping which is inverse to the encryption mapping; an encryption combiner for mapping the encryption result data block to a mapped encryption result data block according to an encryption combining mapping and supplying the mapped encryption result data block to the decryption input of the decrypter; and a controller formed to cause the data block to be encrypted to pass the sequence of encrypter, encryption combiner and decrypter at least once to obtain the encrypted data block.

In accordance with a third aspect, the present invention provides a device for decrypting a data block to be decrypted to a decrypted data block. The device has an encrypter having an encryption input and an encryption output for mapping a data block at the encryption input to an encryption result data block at the encryption output according to an encryption mapping; a decrypter having a decryption input and a decryption output for mapping a data block at the decryption output to a decryption result data block at the decryption output according to a decryption mapping which is inverse to the encryption mapping; a decryption combiner for mapping the encryption result data block to an inversely mapped encryption result data block according to a decryption combining mapping to which the encryption combining mapping is inverse, and supplying the inversely mapped encryption result data block to the decryption input of the decrypter; and a controller formed to cause the data block to be decrypted to pass the sequence of encrypter, decryption combiner and decrypter at least once to obtain the decrypted data block.

In accordance with a fourth aspect, the present invention provides a method for encrypting a data block to be encrypted to an encrypted data block by means of an encrypter having an encryption input and an encryption output for mapping a data block at the encryption input to an encryption result data block at the encryption output according to an encryption mapping, and a decrypter having a decryption input and a decryption output for mapping a data block at the decryption input to a decryption result data block at the decryption output according to a decryption mapping which is inverse to the encryption mapping. The method includes the step of causing the data block to be encrypted to pass the sequence of encrypter and decrypter at least once to obtain the encrypted data block, by mapping the encryption result data block to a mapped encryption result data block according to an encryption combining mapping and supplying the mapped encryption result data block to the decryption input of the decrypter.

In accordance with a fifth aspect, the present invention provides a method for decrypting a data block to be decrypted to a decrypted data block by means of an encrypter having an encryption input and an encryption output for mapping a data block at the encryption input to an encryption result data block at the encryption output according to an encryption mapping, and a decrypter having a decryption input and a decryption output for mapping a data block at the decryption input to a decryption result data block at the decryption output of a decryption mapping which is inverse to the encryption mapping. The method includes the step of causing the data block to be decrypted to pass the sequence of encrypter and decrypter at least once to obtain the decrypted data block, by mapping the encryption result data block to an inversely mapped encryption result data block according to a decryption combining mapping to which the encryption combining mapping is inverse, and supplying the inversely mapped encryption result data block to the decryption input of the decrypter.

In accordance with a sixth aspect, the present invention provides a computer program having a program code for performing one of the above-mentioned methods when the computer program runs on a computer.

The finding of the present invention is that the encryption unit and the decryption unit present in an encryption/decryption device may both be used both when encrypting and decrypting, without their effects canceling each other out when, between the decryption input of the decryption means and the encryption output of the encryption means, encryption combining means is provided which maps the encryption result data block at the encryption output to a mapped encryption result data block according to an encryption combining map and is exemplarily used when encrypting, and further decryption-combining means which maps the encryption result data block at the encryption output to an inversely mapped encryption result data block according to a decryption combining map, which is inverse to the encryption combining map, and is exemplarily used when decrypting.

The setup complexity need thus not be increased enormously since the actual encryption or decryption is performed with a correspondingly high non-linearity of the underlying maps by both means, namely the encryption and the decryption means. The encryption combining and decryption combining maps only serve to ensure that the effects of the encryption map and the decryption map, as are implemented by the encryption and decryption means, do not cancel each other out. Encryption may be effected by a data block to be encrypted to pass at least the sequence of encryption means, encryption combining means and decryption means at least once and to be processed serially by these means. The decryption may then be performed based on the same encryption and decryption means by a data block to be decrypted to pass at least a sequence of encryption means, decryption combining means and decryption means.

Consequently, both means, encryption and decryption means, are used both when encrypting and decrypting, whereas, in the prior art, one of the two means was exclusively responsible for encrypting and the other one exclusively for decrypting. In addition, two different encryption and decryption processes are effectively performed serially, which had conventionally to be achieved by two rounds of the encryption and decryption means.

A special form of the encryption and decryption combining mapping according to an embodiment of the present invention is, for example, an implementation of these mappings in the form of suitably guided conductive tracks such that they perform a permutation of the bits of the encryption result data block from the encryption output to the decryption input or a re-permutation or inverse permutation. Such an implementation hardly consumes any chip area.

### BRIEF DESCRIPTION OF THE DRAWINGS

Preferred embodiments of the present invention will be detailed subsequently referring to the appended drawings, in which:

FIG. 1 shows a block circuit diagram of an encryption/decryption device according to a general embodiment of the present invention;

FIG. 2 is a schematic illustration of an encryption process and a decryption process, as is possible by the device of FIG. 1 according to another embodiment of the present invention;

FIG. 3a is a schematic illustration of an encryption process according to another embodiment of the present invention;

FIG. 3b is a schematic illustration of a decryption process for decrypting a cipher text encrypted according to the encryption of FIG. 3a according to an embodiment of the present invention;

FIG. 4 shows a block circuit diagram of an encryption/decryption device implementing the encryption according to FIG. 3a and the decryption according to FIG. 3b according to an embodiment of the present invention; and

FIG. 5 shows a block circuit diagram of an encryption/decryption device having an encryption unit for encryption and a decryption unit for decryption.

### DESCRIPTION OF PREFERRED EMBODIMENTS

Before the present invention will be explained in greater detail in embodiments referring to the figures, it is to be mentioned that same elements or similar elements in these figures are provided with the same reference numerals or similar reference numerals, a repeated description of these elements being omitted.

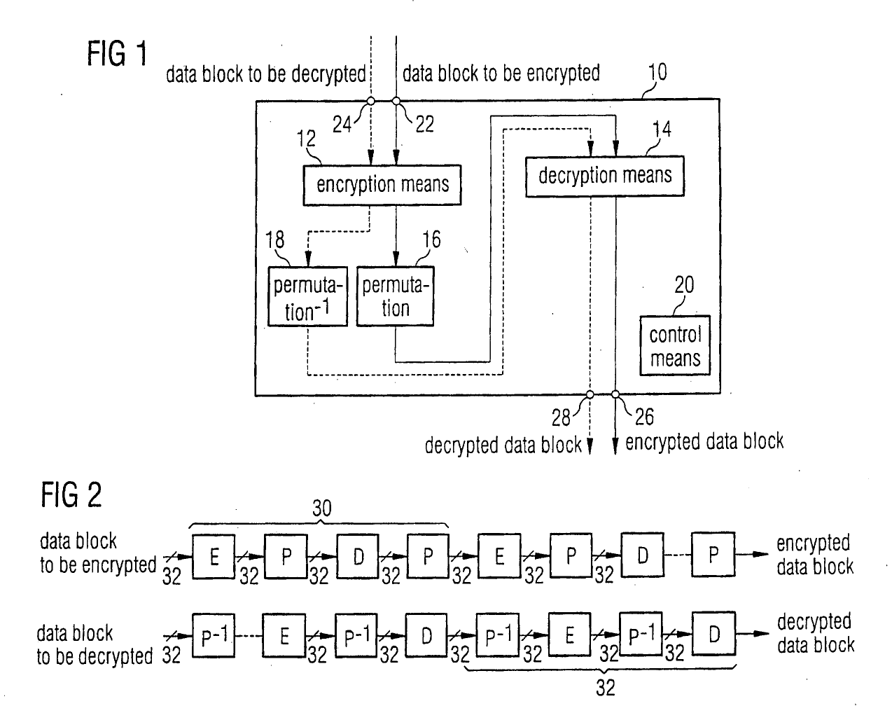

FIG. 1 shows an encryption/decryption device 10 according to an embodiment of the present invention. The encryption/decryption device 10 is able to encrypt arriving data blocks to be encrypted to encrypted data blocks and to decrypt data blocks to be decrypted to decrypted data block.

For this, the encryption/decryption device 10 comprises encryption means 12, decryption means 14, permutation means 16, inverse permutation means 18 and control means 20. Furthermore, the encryption/decryption device includes a data input 22 for the data blocks to be encrypted, a data input 24 for the data blocks to be decrypted, a data output 26 for the data blocks to be encrypted and a data output 28 for the data blocks to be decrypted.

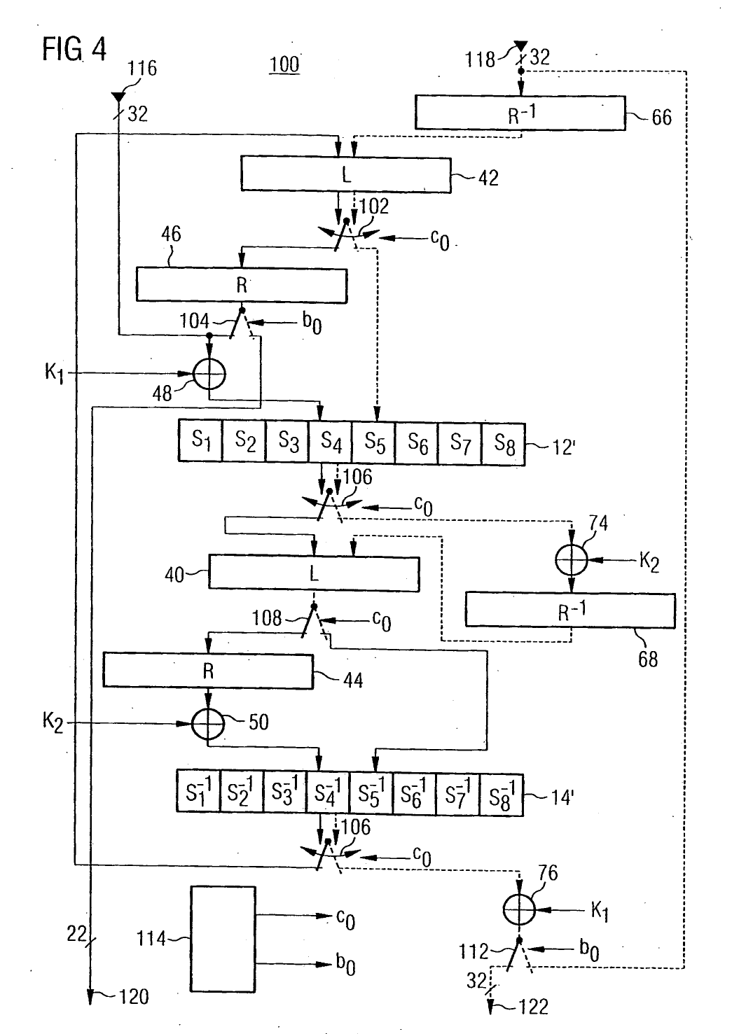

In FIG. 1, the path of a data block to be encrypted in the device 10, i.e. which sequence of means it passes, is indicated by continuous arrows. The broken arrows indicate the sequence of means of the device 10 data blocks to be decrypted pass. This is controlled by control means 20 which exemplarily comprises switches, multiplexers or the like, as will exemplarily be explained in greater detail referring to the embodiment of FIG. 4.

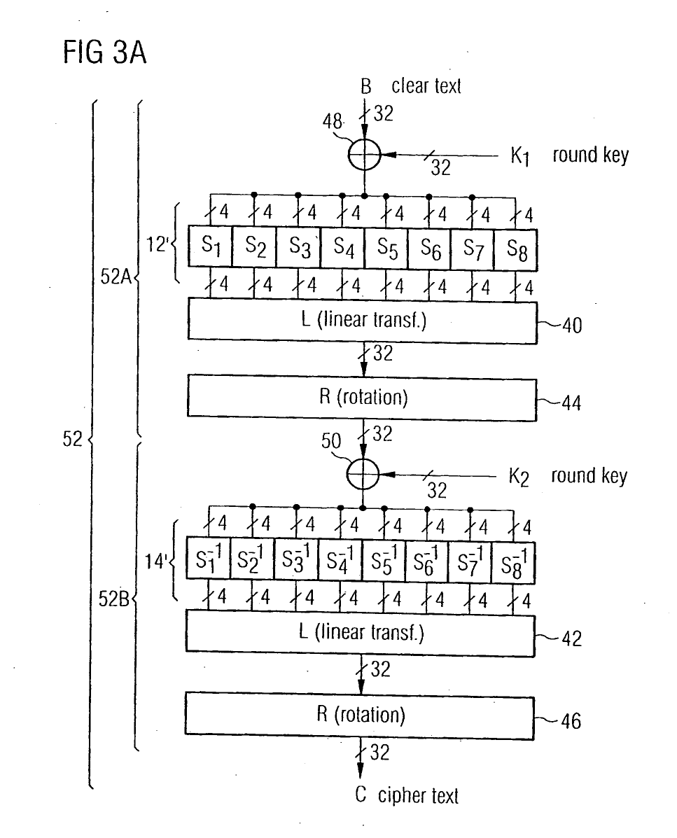

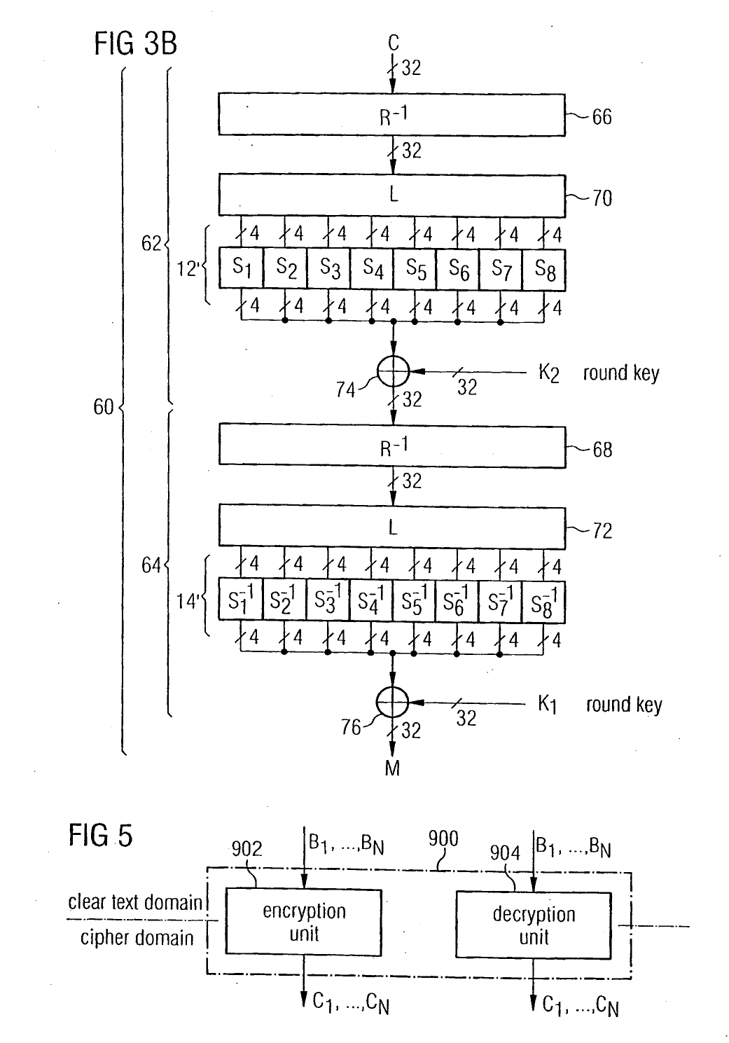

After having roughly described the setup of the device 10, the mode of functioning thereof will now be described in greater detail. The encryption means 12 is formed to map data block at its encryption input block by block to encryption result data blocks according to an encryption mapping and to output the latter at its encryption output. The encryption mapping preferably is a non-linear mapping, mapping n-bit data blocks to m-bit data blocks, n and m being integers, i.e. m,nε|N. In the present embodiment, n=m, wherein m>n might also apply when special further conditions are made to the clear text blocks and the mapping E. As will become evident in the embodiments of FIGS. 3a, 3b and 4, the encryption mapping may exemplarily be implemented using one or several S-boxes. The encryption by the encryption means 12 is subsequently expressed as E (E for encryption), wherein an n-bit data block B is mapped to a cipher text C, which is expressed by E(B)=C.

The decryption means 14 is formed to map data blocks at its decryption input to decryption result data blocks block by block according to a decryption mapping and to output the latter at its decryption output, the decryption mapping being inverse to the encryption mapping. The decryption means 14 consequently implements a mapping D (D for decryption) for which it applies that it is true for each possible unencrypted n-bit data block B that D(E(B))=B, i.e. that the decryption means 14 would always map an original data block at its decryption input E(B) to a data block B at its decryption output, which is mapped by the encryption means 12 to the original data block E(B). This at the same time means that E(D(E(B)))=E(B) has to be true for any B. With m>n, the decryption mapping would thus be a mapping D mapping m-bit data blocks to n-bit data blocks, and would only be defined for E(B) blocks. With a series connection of the mappings, it would have to be ensured that the mapping D only acts on E(B), i.e. on the image quantity of the mapping E. For m=n, as is presently the case, E(D(B))=B is true for any n-bit blocks since the image quantity of E equals the definition quantity of D. Of course, E should preferably be different from D, i.e. E should not be self-inverting.

If the encryption result data blocks at the encryption output of the encryption means 12 were directly fed to the decryption means 14 or its decryption input, their effects would cancel each other out, i.e. a data block at the encryption input of the encryption means 12 would be output unchanged at the decryption output of the decryption means 14. This is, as will be described below, prevented by the permutation means 16 and 18. The decryption means 14 may, like the encryption means 12, also be realized by one or several S-boxes, namely by S-boxes inverse to those forming the encryption means 12.

The permutation means 16 includes an n-bit permutation input and an n-bit permutation output. The permutation means 16 is provided to permute, i.e. re-order, the bits of an n-bit data block at the permutation input and to output the permuted n-bit data block at the permutation output. Put differently, the n-bit data block at the permutation input consists of a sequence of n bits, wherein the order thereof is changed by the permutation by the permutation means 16. The permutation means 18 also comprises a permutation input and a permutation output. It is provided to permute the n bits of an n-bit data block at the permutation input precisely inversely to the permutation of the permutation means 16. This means that, if an n-bit data block having the order of bits was applied to the permutation input of the inverse permutation means 18, as resulted after the permutation by the permutation means 16, the result at the permutation output of the inverse permutation means 18 would again be the n-bit data block having the bit order as was present at the permutation input of the permutation means 16.

Both the permutation means 16 and the inverse permutation means 18 may be implemented as conductive tracks which may connect the individual n bit inputs at the permutation input to different ones of the n bit outputs at the permutation output.

The control means 20 is able to guide data blocks to be encrypted at the input 22 and data blocks 24 to be decrypted through the means 12, 14, 16 and 18 in different ways. According to the embodiment of FIG. 1, the control means 20 provides for a data block to be encrypted at the data input 22 to pass the sequence of encryption means 12, permutation means 16 and decryption means 14. Here, the data block 22 to be encrypted is processed in a sequence by the encryption means 12, the permutation means 16 and the decryption means 14. At first, the data block to be encrypted—it is referred to by B—reaches the encryption input of the encryption means 12. There, it is mapped according to the encryption mapping E to an encryption result data block C=E(B). The n bits of the n-bit encryption result data block C of course define an order. With this order, the encryption result data block C is applied to the permutation means 16. The permutation will subsequently be referred to as P.

A data block having an order of bits changed compared to the encryption result data block C results at the permutation output, i.e. C′=P(C). With this changed order, the data block C′ is applied to the decryption input of the decryption means 14. As has been mentioned, without the permutation, the decryption means 14 would map the block to B. However, it maps the data block C′ according to the decryption mapping D to a decryption result data block which at the same time represents the final result of the encryption according to the present embodiment and is indicated here by Cᵣₑₛᵤₗₜ. Cᵣₑₛᵤₗₜ=D(C′) is true here or, expressed for the entire sequence of mappings passed, Cᵣₑₛᵤₗₜ=D(P(E(B))).

The control means 20 provides for data blocks to be encrypted at the input 24 to pass a different sequence of means, namely the sequence of encryption means 12, inverse permutation means 18 and decryption means 14. It is exemplarily assumed that the data block to be decrypted is the encrypted data block Cᵣₑₛᵤₗₜ just received. This data block Cᵣₑₛᵤₗₜ is fed from the input 24 to the encryption input of the encryption means 12. This applies the encryption mapping E to the data block. The result at the encryption output of the encryption means 12 is an encryption result data block Cᵣₑₛᵤₗₜ′=E(Cᵣₑₛᵤₗₜ)=E(D(P(E(B))))=P(E(B))=C′. The mapping by the encryption means 12 exactly reverses the decryption mapping having been performed at the end of the encryption. The result at the output of the encryption means 12 is an encryption result data block C′ as would also be obtained by sequentially applying the encryption mapping E and the permutation P to the original encrypted data block.

The result encryption data block C′ at the output of the encryption means 12 is then supplied to the permutation input of the inverse permutation means 18. This process changes the order of the n bits of the n-bit encryption result data block in a manner which is inverse to that applied for obtaining the encryption intermediate result C′ when encrypting. The result at the permutation output 18 is Cᵣₑₛᵤₗₜ″=P⁻¹(P (E (B)))=E(B)=C. The encryption result data block C′ is consequently, when decrypting, not applied to the decryption input of the decryption means 14 in the order of bits as is present at the encryption output, but in an order changed by the inverse permutation means 18, i.e. as Cᵣₑₛᵤₗₜ″=C. The decryption means 14 maps this data block C at its decryption input to D(E(B))=B according to the decryption mapping D, i.e. again the data block in clear text.

Consequently, the device 10 of FIG. 1 is able to both encrypt data blocks in clear text to cipher text data blocks and to decrypt cipher text data blocks back to data blocks in clear text, wherein the encryption means 12 and the decryption means 14 take part when processing the data blocks to be encrypted or decrypted both in encryption and decryption.

Referring to the description of FIG. 1, it is to be mentioned briefly that it would of course be possible not to “steer” the data blocks to be encrypted and to be decrypted at first through the encryption means 12 but through the decryption means 14 and only at the end through the encryption means 12, so that the result for a data block B to be encrypted would be the cipher text Cᵣₑₛᵤₗₜ=E(P(D(B))) and, inversely, the result for the cipher text Cᵣₑₛᵤₗₜ would again be the clear text data block B of E(P⁻¹(D(Cᵣₑₛᵤₗₜ))), as long as n=m.

It is noted with reference to FIG. 1 that it could be achieved by means of suitably limiting the allowed n-bit clear text data blocks among the possible n-bit combinations and a suitable definition of E as a mapping of n- to m-bit data blocks and of P that, for m>n, E(D(P(B)))=P(B) is true for all Bs allowed and all possible Ps, exemplarily with n=3 and m=6 when it is ensured that all 8 allowed 3-bit data blocks are mapped by E to only 8 of the 68 possible 6-bit data blocks and the permutation only takes place such that the permuted block P(B) again is one among the eight ones from the 120 possible ones, or with n=5 and m=6 when only 30 of the 32 possible 5-bit data blocks are allowed and these are only mapped by E to the 30 of the 68 possible 6-bit data blocks, have two bits with 1 and 4 bits with 0 or vice versa, since each 6-bit data block will again be mapped to one such having the same feature by a permutation.

Subsequently, it will be assumed that n=m. It is possible in this case that the control means 20 has the data blocks to be encrypted pass the sequence of encryption means 12, permutation means 16 and decryption means 14 more than only once and correspondingly also has the data blocks to be decrypted pass the sequence of encryption means 12, inverse permutation means 18 and decryption means 14 several times. The multiple passing can increase the safety of the encrypted data stored.

FIG. 2 shows schematic sequences of processing which the control means 20 provides for when encrypting or decrypting according to an embodiment of the present invention. In FIG. 2, it is exemplarily assumed that n=m=32, i.e. that the data block to be encrypted and the data block to be decrypted and the encrypted and decrypted data blocks each have a length of 32 bits.

The upper line of FIG. 2 illustrates the flow when encrypting as is caused by the control means 20. A data block to be encrypted (to the very left) is subjected to equal serial processing iteratively one after the other or repeatedly in so-called rounds 30. Each round 30 includes a sequence of encryption mapping E, permutation P, decryption D and permutation P. Again shortly referring to FIG. 1, this means that the control means 20 repeatedly guides data blocks to be encrypted through the encryption means 12, the permutation means 16, the decryption means 14 and the permutation means 16, sequentially in this order. The result at the end (to the very right in FIG. 2) would be the encrypted data block at the output 26.

The decryption in FIG. 2 is illustrated in the bottom line. A data block to be decrypted is subjected to a sequence of mappings, resulting when the upper line is read inversely, i.e. starting at the right-hand side, i.e. inverses the processing order, and inverting each mapping, i.e. reads P⁻¹ instead of P, reads E instead of D and reads D instead of E, i.e. exchanges each means by its inverse means. Data blocks to be decrypted are consequently also processed in rounds 32, wherein each round 32 comprises a sequence of mappings P⁻¹, E, p⁻¹ and D. The result at the end (to the very right in FIG. 2) is a decrypted data block.

It becomes obvious from FIG. 2 that the rounds 30 and 32 actually are double rounds where an encryption E and a decryption or decryption mapping D′ are performed. Both in encryption and decryption, in the embodiment of FIG. 2, the encryption means and the decryption means or the underlying hardware are employed equally in a time-offset manner. An encryption according to the upper line in FIG. 2 may of course be performed in the device of FIG. 1 simultaneously with a decryption according to the bottom line in FIG. 2 when both processes are executed in a pipeline-offset manner to each other such that the encryption means E is being used for the encryption while the decryption means is operating for the decryption.

The embodiment of FIG. 2 may, of course, be varied at will. It is not compulsory that only the permutation P is used when encrypting, whereas only the inverse permutation P⁻¹ is used when decrypting. Alternatively, a decryption round 30 may exemplarily also be E, P, D, P⁻¹, whereas the corresponding decryption round 32 would be P, E, P⁻¹, D.

In the above embodiments of FIGS. 1 and 2, little has been said about the implementation of the encryption and decryption means. Referring to FIGS. 3a, 3b and 4, embodiments where the encryption mapping and the decryption mapping are implemented by 4×4 S-boxes each mapping four different bits of the data block at the encryption input to four different bits of the data block at the encryption output will be described below. The advantage here is that the implementation of an S-box, such as, for example, of a 32-bit S-box, means less hardware complexity when implemented by smaller S-boxes, such as, for example eight 4×4 S-boxes.

FIG. 3a shows an encryption according to an embodiment of the present invention. Like in the embodiment of FIG. 1, several means are available for encryption, wherein for each means performing a certain mapping there is another means performing the respective inverse mappings. In the embodiment of FIG. 3a, 4×4 S-boxes S₁-S₈ serve as encryption means 12′, wherein eight inverse S-boxes S₁⁻¹ to S₈⁻¹ serve as decryption means 14′. In addition, two identical mapping means 40 and 42 are available outputting a 32-bit data block at their 32-bit data input to a 32-bit data block at their data output according to a self-inverting linear mapping or linear transformation L. In addition, two rotation means 44 and 46 are provided rotating a 32-bit data block at their rotation input by a certain number of bits in a predetermined direction according to a bit rotation R and outputting the result of the rotation at their rotation output. Finally, two 32-bit XOR combining means are provided each consisting of 32 XOR gates which, bit by bit, subject the 32 bits of a 32-bit data block with the bits of a 32-bit round key, once K₁ and the other time K₂, to an XOR combination and output the result as a 32-bit data block. These XOR combining means are indicated by 48 and 50, respectively.

According to the encryption example of FIG. 3a, a clear text data block B passes only one double round 52, i.e. a processing sequence which once or in one sub-round comprises an encryption 12′ and the other time or in the other sub-round comprises a decryption 14′. The double round 52 is thus divided into two sub-rounds, namely 52a and 52b, which are performed sequentially. The first sub-round 52a the clear text data block B passes consists of the sequence of XOR combination 48 with the round key K₁, encryption mapping by the S-boxes S₁-S₈, linear transformation 40 and subsequent rotation 44. After passing the sub-round 52a, processing by the sub-round 52b takes place, comprising a sequence of XOR combination with the round key K₂, decryption mapping by the inverse S-boxes S₁⁻¹-S₈⁻¹, linear transformation 42 and rotation 46. The cipher text C or the cipher text data block C results after the sub-round 52b.

Expressed in greater detail, according to the embodiment of FIG. 3a, a data block B to be encrypted passes the XOR combining means 48. The result at the output of the XOR combining means 48 is a data block, the bits of which are inverted to the corresponding bits of the data block B at the positions where the round key K₁ comprises a logical one, whereas the remaining bits are identical to the corresponding bits of the data block B.

After that, the bits are supplied to the S-box inputs of the S-boxes S₁-S₈, i.e. the four most significant bits 31-28 of the S-box S₁, the next less significant bits 27-24 of the S-box S₂, etc. The S-boxes S₁-S₈ map the 4-bit words at their S-box inputs to mapped 4-bit words according to a mapping rule associated thereto, which is preferably non-linear and different for all S-boxes. The four bits at the S-box outputs of the S-boxes S₁-S₈ are then supplied as a 32-bit data block to a 32-bit data input of the linear transforming means 40, i.e. in turn the four bits of the S-box S₁ as the four most significant bits 31-28, the four bits output of the S-box S₂ as the next less significant bits 27-24, . . . and the bits of the S-box S₈ as bits 3-0.

The linear transforming means 40 maps the data block at its data input to another 32-bit data block by a linear mapping. In the present embodiment, the linear mapping L is even self-inverting so that the double execution of L at a data block one after the other would again result in the data block, i.e. L(L(B))=B. The resulting data block at the data output of the linear transforming means 40 is passed on to the rotating means 44 which shifts the bits of the data block at its data input by a number of bits depending on the rotation R to the right or the left and attaches the bits shifted out again at the bit positions released. The data block at the output of the rotation means 44 thus represents the result of the first sub-round 52a.

This 32-bit data block is then again subjected to an XOR combination 50 with one round key K₂, wherein again those bit positions where the round key K₂ has a logical one invert. Four respective subsequent bits of the resulting data block are then supplied to the inverse S-boxes S₁⁻¹-S₈⁻¹ at their S-box inputs which then perform inverse mappings at the supplied 4-bit words, i.e. the S-box S₁⁻¹ a mapping inverse to the mapping of the S-box S₁, the S-box S₂⁻¹ a mapping inverse to the mapping of the S-box S₂, etc. The 4-bit words at the S-box outputs of the S-boxes S₁⁻¹-S₈⁻¹ in turn form a 32-bit data block which is applied to the linear transforming means 42 which executes the same linear transformation as the linear transforming means 40. The result of the linear mapping is a 32-bit data block supplied to the input of the rotation means 46 which rotates this data block by the same number of bits in the same direction as the rotation means 44. The resulting 32-bit data block is the cipher text C or the cipher data block C.

Like in the embodiment of FIG. 2, passing several double rounds 52 could also be provided to perform an encryption, as is also provided in the implementation of the encryption of FIG. 3a according to the embodiment of FIG. 4. As may be seen from the illustration of the encryption sequence of FIG. 3a, a mapping is performed between each encryption and decryption mapping 12′ and 14′, respectively, which may be referred to as an encryption combining mapping. While this combining encryption mapping in the embodiment of FIG. 1 was exemplarily the permutation P, in the embodiment of FIG. 3a this is the sequence of linear transformation L, rotation R and XOR round key combination 50. While the S-boxes S₁-S₈ and S₁⁻¹ S₈⁻¹ cause confusion in the cipher text, i.e. cause the relation between the round keys and the cipher text to be as complex as possible, the linear mappings L cause, by several XOR combinations of the bits in the individual data blocks, that small changes in the clear text data block have great effects on the cipher text data block. Above all, the linear transformations L, however, cause the bits output by the S-boxes S₁-S₈ to be effectively mixed with further bits of further bit positions and shifted to other bit positions in order for them not to reach certain subsequent inverse S-boxes by a simple rotation.

Referring to FIG. 3a, it is also pointed out that, when describing the encryption process, it is assumed that two linear transforming means 40 and 42 and two rotation means 44 and 46 and two XOR combining means 48 and 50 are provided. However, this is not necessary. The same means could be passed with each sub-round 52a-52b, i.e. in the sub-round 52a the same linear transforming means like in the sub-round 52b, in the sub-round 52a the same rotation means like in the sub-round 52b and in the sub-round 52a the same XOR combining means using the key K₁ like in the sub-round 52b, wherein in the latter, however, the round key K₂ is used. The multiple usage of these means would only increase the amount of control for the control means (not shown) to provide for the clear text data block B or the intermediate results derived therefrom to pass the means in the suitable order. The embodiment of FIG. 4 still to be discussed refers to an example of implementation for the encryption flow of FIG. 3a using two respective means, as is illustrated in FIG. 3a.

FIG. 3b shows a decryption round for decrypting a cipher text data block C as is obtained by an encryption round 52 of FIG. 3a. The decryption round is generally indicated by 60. It again consists of two sub-rounds 62 and 64. A cipher text data block C passes the same S-boxes S₁-S₈ and S₁⁻¹-S₈⁻¹, respectively, in a decryption round like in the encryption round of FIG. 3a or the same encryption and decryption means 12′ and 14′. The remaining means may, depending on the implementation, be selected to be partly identical to the means when encrypting or be provided separately for decryption. In FIG. 3b, the remaining means are provided with separate reference numerals as if they were different from those of FIG. 3a, wherein the embodiment illustrates an opposite way of implementation with regard to the linear mapping means.

During a decryption round 60, a cipher text data block C passes two inverse rotation means 66, 68, two linear transforming means 70 and 72 and two XOR combining means 74 and 76.

When decrypting, the mappings are performed on the cipher text data block as they are also performed on the clear text data block in the case of encryption, but in an inverse order, and inverted. This means that, corresponding to the rotation 46 of FIG. 3a, at first an inverse rotation is performed by the rotation means 66 on the cipher text data block C, i.e. shifting of the bits of the cipher text data block C by a number of bits identical to that of the rotation R, but in the opposite direction. The 32-bit data block bit-rotated in this way is passed on to the linear transforming means 70. It performs the same linear mapping on the incoming data block as do the linear transforming means 40 and 42 and also the linear transforming means 72. The reason is that, as has been explained above, the linear mapping according to the present embodiment is self-inverting, such that L(L(B))=B. After that, corresponding to the pass of the S⁻¹-boxes of FIG. 3a, the 32-bit data block resulting at the output of the linear transforming means 70 is supplied to the S-boxes S₁-S₈ as the encryption means 12′ in units of 4-bit words. The resulting 32 bits are XOR-combined with the round key K₂. This combination corresponds to the combination 50 of FIG. 3a. Also, the XOR combination 50 is, as is the self-inverting mapping L, a self-inverting mapping since the repeated inverting of the bits at the bit positions where the 2-bit round key K₂ comprises a one, provides the original data block again. The result of the XOR combination 74 is the result of the sub-round 62. The sub-round 64 following the sub-round 62 corresponds to an inversion of the sub-round 52a of the encryption round 52 of FIG. 3a. There, the data block is sequentially supplied to the inverse rotation means 68, the linear transforming means 72, the inverse S-boxes 14′ and the XOR combination with the round key K₁, whereupon the clear text data block M is obtained, as has been encrypted to form the cipher text C in FIG. 3a.

Referring to FIG. 4, an implementation of an encryption/decryption device which is able to perform encryption and decryption in the manner described in FIGS. 3a and 3b will be described. Thus, the encryption/decryption device of FIG. 4 includes the means of FIG. 3a and additionally some means of FIG. 3b. However, the linear transforming means of FIG. 3a are shared for encryption and decryption such that, in FIG. 4, they only have the reference numerals of FIG. 3a, i.e. 40 and 42, and the linear transforming means 70 and 72 have been implemented by the same actual means.

The encryption/decryption device of FIG. 4 is generally indicated by 100. The encryption/decryption device 100 includes, apart from the inverse rotating means 66, 68, the linear transforming means 42, 40, the rotating means 46, 44, the XOR combining means 48, 50, 74 and 76, the S-boxes S₁-S₈ and the inverse S-boxes S₁⁻¹-S₈⁻¹, switches 102, 104, 106, 108, 110 and 112 and a control unit 114. A data input 116 is provided for receiving the data blocks to be encrypted, a data input 118 is provided for receiving the data blocks to be decrypted, an output 120 is provided for outputting the encrypted data blocks and an output 122 is provided for outputting the decrypted data blocks.

In FIG. 4, the lines connecting the means are each 32-bit lines and are illustrated either by a broken line or by a continuous line, wherein broken lines indicate the data path relevant for decryption, whereas the continuous lines are used when encrypting. Data inputs of means and data lines shared when encrypting and decrypting are illustrated by parallel broken and continuous lines. The arrows are to make reading the encryption/decryption device easier. Starting with the encryption part, the 32-bit XOR combining means 48 is connected with its output to the input of the S-boxes S₁-S₈. The output of the S-boxes S₁-S₈ is connected to a 32-bit input of the 32-bit switch 106. The switch comprises two 32-bit outputs and is provided to connect the switch input, corresponding to a control signal c₀ it obtains at a control input from the control unit 114, to either one switch output or the other switch output. As will be explained in greater detail below, a first one of the switch outputs is associated to encryption rounds, whereas the other switch output is fixedly associated to decryption rounds. The encryption switch output is connected to an input of the linear transforming means 40. The output of the linear transforming means 40 is connected to a 32-bit switch input of the switch 108. Also, the switch 108 obtains, at a control input thereof, the signal c₀ from the control unit 114 and correspondingly connects the switch input to either a 32-bit encryption switch output or a 32-bit decryption switch output.

The encryption switch output of the switch 108 is connected to an input of the rotation means 44. An output of the rotations means 44 is connected to a data input of the encryption means 50 containing the round key K₂ at its 32-bit key input, whereas the round key K₁ is at the key input of the key means 48. The output of the XOR combining means 50 is connected to an input of S₁⁻¹-S₈⁻¹. The outputs of the latter are connected to a 32-bit switch input of the switch 110 which, as do the switches 106 and 108, obtains the control signal c₀ from the control means 114 at a control input thereof and connects, depending thereon, the 32-bit control input to either a 32-bit encryption switch output or a 32-bit decryption switch output. The encryption switch output of the switch 110 is connected to an input of the linear transforming means 42, the output of which in turn is connected to a 32-bit switch input of the switch 102. This switch 102 also obtains, at a control input thereof, the control signal c₀ from the control unit 114 and correspondingly switches the switch input to either a 32-bit encryption control output or a 32-bit decryption switch output. The 32-bit encryption switch output of the switch 102 is connected to an input of the rotating means 46, the output of which in turn is connected to a 32-bit switch input of the switch 104. This switch 104 obtains, at a control input thereof, a control signal b₀ from the control unit 114 and comprises a 32-bit round terminating switch output and a 32-bit round continuation switch output. Depending on the signal b₀, the switch 104 connects the switch input to either the round terminating switch output or the round continuation switch output. The round continuation switch output is connected to the input of the XOR combining means 48, whereas the round terminating switch output is connected to the output 120 of the means 100.

With regard to decryption, the input 118 is connected to an input of the inverse rotating means 66. Its output in turn is connected to the input of the linear transforming means 42. The decryption switch output of the switch 102 is connected to the input of the S-boxes S₁-S₈. The decryption switch output of the switch 106 is connected to a data input of the XOR combining means 74 which obtains the round key K₂ at its key input and is connected with its data output to an input of the inverse rotating means 68. The output of the inverse rotating means 68 is connected to the input of the linear transforming means 40. The decryption switch output of the switch 108 is connected to the input of the inverse S-boxes S₁⁻¹-S₈⁻¹. The decryption key output of the switch 110 is connected to the data input of the XOR combining means 76 which obtains the round key K₁ at its key input and which is connected with its data output to a switch input of the switch 112. The switch 112 obtains at a control input thereof the control signal b₀ from the control unit 114 and correspondingly connects the switch input to either a decryption round terminating switch output or a decryption round continuation switch output. The decryption round continuation switch output of the switch 112 is connected to the input of the inverse rotating means 66, whereas the decryption round terminating switch output is connected to the output 122 of the device 100.

After having described above the setup of the device of FIG. 4, its mode of functioning will be described below.

It is assumed for illustration purposes that the encryption/decryption device 100 of FIG. 4 is formed to perform two encryption (double) rounds and two decryption (double) rounds, wherein the description, however, may easily be extended to more double rounds.

An encryption will be considered first. A data block to be encrypted is at the data input 116. Then, the control unit 114 drives all the switches 102, 106, 108 and 110 by the signal c₀ such that they connect their respective control input to the encryption control output. This simply means that the order of means the data block to be encrypted at the input 116 passes is determined up to the switch 104, namely the order of XOR combining means 48, S-boxes 12′, linear transforming means 40, rotating means 44, XOR combining means 50, inverse S-boxes 14′, linear transforming means 42, rotating means 46, as has already been described referring to FIG. 3a.

The control unit 114 does not have to change the signal c₀ while the data block passes this sequence. Generally, the control unit 114 does not change the signal c₀ for the entire encryption process, i.e. not even for the subsequent rounds. The control signal c₀ remains the same for the entire encryption process such that only a little amount of control for control unit 114 results. The control unit 114 provides for, by means of the control signal b₀, the switch 104 to connect, after the first round pass, i.e. after processing by the rotating means 46, its switch input to the encryption round continuation switch output such that the intermediate result or data block the rotating means 46 outputs is again applied to the XOR combining means 48 which forms the beginning of the encryption round determined by the switches 106, 108, 110 and 102.

After the second pass or the second processing by the rotating means 46, the control unit 114 provides for the switch 104 to switch the switch output to the encryption round terminating switch output (switch position indicated in broken lines) such that the cipher text or cipher text data block is output at the data output 120, as results after a double round pass 52, as is illustrated in FIG. 3a.

When decryption is to be performed, the control unit 114 provides for, by the control signal c₀, the switches 102, 106, 108 and 110 to connect their control input to the decryption control output (in FIG. 4 the switch state not illustrated). The result is that a data block to be decrypted applied to the data output 118 is to be directed easily through a sequence of means corresponding to the sequence of FIG. 3b, namely the sequence of inverse rotating means 66, linear transforming means 42, S-boxes S₁-S₈, XOR combining means 74, inverse rotating means 68, linear transforming means 40, inverse S-boxes 14′, XOR combining means 76. The control signal b₀ sets the control unit 114 such that the switch 112 again applies the data block resulting after the first decryption round to the input of the inverse rotating means 66, i.e. such that the switch 112 connects its switch input to the decryption round continuation switch output. The control unit 114 provides for, by switching the signal b₀, the data block finally resulting to be output as the decrypted data block at the output 122 after the second passing of the decryption round, by the switch 112 switching its control input to the decryption round terminating switch output (switch position indicated in broken lines).

The previous embodiments are suitable for being used as an encryption of memory contents as a protection against unauthorized readout of these memory contents. However, the embodiments may also be used for an online or bus encryption in other applications when, for example, the encryption hardware behind it is to be kept small.

The previous embodiments of FIGS. 3a-4 have related to an encryption/decryption by a cryptographically full block cipher. Calculating back or drawing conclusions from the data present in encrypted form to the clear text is not possible for an attacker or only possible entailing excessive complexity. In the embodiment of FIG. 4, for example, or of FIG. 2, the hardware implementation, for example, does not consume a large area since the block cipher is planned with a variable number of rounds. Thus, the cryptographic power of the encryption is scalable compromising performance or speed, but not compromising the area. The more rounds are passed, the higher is the encryption power.

In all previous embodiments, the area required for the implementation has been kept small although both encryption and decryption were equally performed. This has been achieved in the embodiments of FIGS. 3a-4 by passing S-box layers. When the first layer contains the S-box S, the second layer will contain the respective inverse S-box Inv(S′)=S⁻¹.

In the embodiments of FIGS. 3a-4, rotation has been used. It would, of course, also be possible to generally replace the rotation by a permutation. In any case, the permutation or rotation ensures that the effects of the S-boxes do not weaken one another.

In the embodiments of FIGS. 3a-4, a self-inverting linear transformation has been used as another principle. A linear transformation L is called self-inverting when L(L(x))=x is true for all input vectors x. In a second variation of realization, a pair of linear transformations L₁ and L₂ being inverse to each other might be used instead of one self-inverting linear transformation L. Then, L₁(L₂(x))=L₂(L₁(x))=x is true for all input vectors x.

The S-boxes of the embodiments 3a-4 cause confusion, the linear transformations cause diffusion of the clear text bits. By introducing a corresponding number of multiplexers or switches, one and the same module was able to also perform decryption by a control unit providing for, by these switches or multiplexers, the means to be coupled in accordance with a corresponding sequence of means. In contrast to the embodiment of FIG. 4, the control, however, may also take place dynamically during a double round such that one means is passed twice during a double round. In this way, for example in the embodiment of FIG. 4, the linear transforming means 40, 42, the inverse rotating means 66, 68 and the rotating means 46 and 44 could be replaced by one each. The disadvantage would be the increased control complexity for the control unit 114, wherein the advantage is the smaller chip area.

In the end, this means for each embodiment described before that the same piece of hardware is used both for encryption and for decryption.

With regard to the above description, it is also pointed out that, although it has been described above that in the encryption mappings the length of the original data blocks is smaller than or equal to that of the data block resulting from the encryption mapping S (i.e. n≦m), it is also possible to equally select n>m like in the DES algorithm, such as, for example, several 6×4 S-boxes when, for example, expansion of the data block providing redundancy is performed before the encryption S or compression after the decryption S⁻¹.

In contrast to Feistel ciphers and the implementing encryption/decryption devices thereof, the embodiments of the present invention have the advantages that no high round number is required to obtain the same safety level, which in turn increases the performance or effectiveness compared to these Feistel cipher encryption/decryption devices.

The above embodiments have only required a minimum of elementary elements, namely exemplarily in the embodiments of FIGS. 3a-4 S-boxes and linear transformations. With each elementary element used, the respective inverse elementary element is also contained in the encryption/decryption device. It can then reverse the operation of the elementary element, which is made use of for decryption. Attention has been paid to the fact that for encryption the effects of the elementary elements and the inverse elementary elements do not weaken or even cancel out one another, but supplement one another. As has been described with regard to rotation and permutation, this can be achieved by a suitable wiring which does not consume extra area. Mathematically, such a wiring corresponds to a permutation or rotation of data bits.

With regard to the above description, it is noted that the number of rounds, i.e. the number of double rounds, is not determined to be one or two, but may take any other value. The encryption rounds of FIGS. 3a and 3b may be passed as often as desired. The cipher text C then correspondingly represents a 1, 2, . . . N double round encryption or a 2, 4, 6, . . . 2N round encryption, Nε|N.

The encryption means may neutrally be considered as a first mapping means with a first mapping and the decryption means as a second mapping means with a corresponding mapping inverse to the first one.

It is particularly noted that, depending on the circumstances, the inventive scheme for encryption/decryption may also be implemented in software. The implementation may be on a digital storage medium, in particular on a disc or a CD having control signals which may be read out electronically, which can cooperate with a programmable computer system such that the corresponding method will be executed. In general, the invention also is in a computer program product having a program code stored on a machine-readable carrier for performing the inventive method when the computer program product runs on a computer. Put differently, the invention may thus be realized as a computer program having a program code for performing the method when the computer program runs on a computer.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

What is claimed is:

1. A device for encrypting a data block to be encrypted to an encrypted data block and for decrypting a data block to be decrypted to a decrypted data block, comprising:
an encrypter having an encryption input and an encryption output for mapping a data block at the encryption input to an encryption result data block at the encryption output according to an encryption mapping;
a decrypter having a decryption input and a decryption output for mapping a data block at the decryption input to a decryption result data block at the decryption output according to a decryption mapping which is inverse to the encryption mapping;
an encryption combiner for mapping the encryption result data block to a mapped encryption result data block according to an encryption combining mapping and supplying the mapped encryption result data block to the decryption input of the decrypter;
a decryption combiner for mapping the encryption result data block to an inversely mapped encryption result data block according to a decryption combining mapping to which the encryption combining mapping is inverse and supplying the inversely mapped encryption result data block to the decryption input of the decrypter; and
a controller formed to cause the data block to be encrypted to pass the sequence of encrypter, encryption combiner and decrypter at least once to obtain the encrypted data block and the data block to be decrypted to pass the sequence of encrypter, decryption combiner and decrypter at least once to obtain the decrypted data block.

2. The device according to claim 1, wherein the encryption combiner and the decryption combiner are formed to supply the encryption result data block to the decryption input of the decrypter such that when mapping the identity, instead of the encryption combining or decryption combining mapping, a data block would, when passing the sequence of encrypter, encryption combiner and decrypter and passing the sequence of encrypter, decryption combiner and decrypter be mapped to itself.

3. The device according to claim 1, wherein the data block to be encrypted, the encrypted data block, the data block to be decrypted and the decrypted data block are n-bit data blocks, n being a predetermined integer.

4. The device according to claim 1, wherein the encrypter comprises an n-bit encryption input and an m-bit encryption output and is formed to map an n-bit data block at the encryption input to an m-bit encryption result data block at the encryption output according to the encryption mapping, and wherein the decrypter comprises an m-bit encryption input and an n-bit decryption output and is formed to map an m-bit data block at the decryption input to an n-bit encryption result data block at the decryption output according to the decryption mapping.

5. The device according to claim 4, wherein the encryption mapping and the decryption mapping are non-linear mappings.

6. The device according to claim 4, wherein the encryption combiner comprises:
a first permuter having a first m-bit permutation input and a first m-bit permutation output for permuting an m-bit data block at the first m-bit permutation input to a permuted m-bit data block at the first m-bit permutation output according to a permutation rule, wherein the first permuter is switchable serially between the m-bit encryption output and the m-bit encryption input, and
wherein the decryption combiner comprises:
a second permuter having a second m-bit permutation input and a second m-bit permutation output for permuting an m-bit data block at the second m-bit permutation input to a permuted m-bit data block at the second m-bit permutation output according to a second permutation rule which is inverse to the first permutation rule, wherein the second permuter is switchable serially between the m-bit encryption output and the m-bit decryption input,
wherein the first and second permuters are switchable between the m-bit encryption output and the m-bit decryption output such that a pass of the data block to be encrypted through the sequence of encrypter, encryption combiner and decrypter results in a data block which would again result in the data block to be encrypted when passing the sequence of encrypter, decryption combiner, decrypter.

7. The device according to claim 6, wherein the first permuter and the second permuter are each implemented as m conductive tracks extending between the first and second permutation inputs on the one hand and the first and second permutation outputs, respectively, on the other hand.

8. The device according to claim 4, wherein the encryption combiner comprises:
a first linear mapper having a first m-bit linear mapping input and a first m-bit linear mapping output for mapping an m-bit data block at the first m-bit linear mapping input to a mapped m-bit data block at the first m-bit linear mapping output according to a first linear mapping, wherein the first linear mapper is switchable serially between the m-bit encryption output and the m-bit decryption input, and
wherein the decryption combiner comprises:
a second linear mapper having a second m-bit linear mapping input and a second m-bit linear mapping output for mapping an m-bit data block at the first m-bit linear mapping input to a mapped m-bit data block at the second m-bit linear mapping output according to a second linear mapping, the second linear mapping being inverse to the first linear mapping, and wherein the second linear mapper is switchable serially between the m-bit encryption output and the m-bit decryption input,
wherein the first and second linear mappers are switchable between the m-bit encryption output and the m-bit decryption input such that a pass of the data block to be encrypted through the sequence of encrypter, encryption combiner and decrypter results in a data block which would result again in the data block to be encrypted when passing the sequence of encrypter, decryption combiner and decrypter.

9. The device according to claim 4, wherein the encryption combiner comprises:
a first key XOR operator having a first m-bit data input, a first m-bit key input and an m-bit data output for XOR-combining bit by bit an m-bit data block at the first m-bit data input with an m-bit key at the m-bit key input, wherein the first key XOR operator is switchable serially between the m-bit encryption output and the m-bit decryption input, and
wherein the decryption combiner comprises:
a second key XOR operator having a second m-bit data input, a second m-bit key input and a second m-bit data output for XOR-combining bit by bit an m-bit data block at the second m-bit data input with the m-bit key at the second m-bit key input, wherein the second key XOR operator is switchable serially between the m-bit encryption output and the m-bit decryption input,
wherein the first and second key XOR operators are switchable between the m-bit encryption output and the m-bit decryption input such that a pass of the data block to be encrypted through the sequence of encrypter, encryption combiner and decrypter results in a data block which would result again in the data block to be encrypted when passing the sequence of encrypter, decryption combiner, decrypter.

10. The device according to claim 4, wherein m=n.

11. The device according to claim 1, wherein the encrypter comprises several p×p encryption S-boxes each of which maps different p bits of the data block at the encryption input to p bits which together form the encryption result data block, and the decrypter comprises several p×p decryption S-boxes each of which maps different p bits of the data block at the decryption input to p bits which together form the decryption result data block, wherein each of the decryption S-boxes implements a mapping which is inverse to a different one of the encryption S-boxes.

12. The device according to claim 1, wherein the controller is formed to cause a data block to be encrypted to pass a sequence of encrypter, encryption combiner, decrypter, encryption combiner once or several times to obtain the encrypted data block, and the data block to be decrypted to pass a sequence of decryption combiner, encrypter, decryption combiner and decrypter once or several times to obtain the decrypted data block, or the data block to be encrypted to pass a sequence of encrypter, encryption combiner, decrypter, decryption combiner once or several times to obtain the encrypted data block, and the data block to be decrypted to pass a sequence of encryption combiner, combiner, decryption combiner and decrypter once or several times to obtain the decrypted data block.

13. A device for encrypting a data block to be encrypted to an encrypted data block, comprising:
an encrypter having an encryption input and an encryption output for mapping a data block at the encryption input to an encryption result data block at the encryption output according to an encryption mapping;
a decrypter having a decryption input and a decryption output for mapping a data block at the decryption input to a decryption result data block at the decryption output according to a decryption mapping which is inverse to the encryption mapping;
an encryption combiner for mapping the encryption result data block to a mapped encryption result data block according to an encryption combining mapping and supplying the mapped encryption result data block to the decryption input of the decrypter; and
a controller formed to cause the data block to be encrypted to pass the sequence of encrypter, encryption combiner and decrypter at least once to obtain the encrypted data block.

14. A device for decrypting a data block to be decrypted to a decrypted data block, comprising:
an encrypter having an encryption input and an encryption output for mapping a data block at the encryption input to an encryption result data block at the encryption output according to an encryption mapping;
a decrypter having a decryption input and a decryption output for mapping a data block at the decryption output to a decryption result data block at the decryption output according to a decryption mapping which is inverse to the encryption mapping;
a decryption combiner for mapping the encryption result data block to an inversely mapped encryption result data block according to a decryption combining mapping to which the encryption combining mapping is inverse, and supplying the inversely mapped encryption result data block to the decryption input of the decrypter; and
a controller formed to cause the data block to be decrypted to pass the sequence of encrypter, decryption combiner and decrypter at least once to obtain the decrypted data block.

15. A method for encrypting a data block to be encrypted to an encrypted data block by means of an encrypter having an encryption input and an encryption output for mapping a data block at the encryption input to an encryption result data block at the encryption output according to an encryption mapping, and a decrypter having a decryption input and a decryption output for mapping a data block at the decryption input to a decryption result data block at the decryption output according to a decryption mapping which is inverse to the encryption mapping, the method comprising the step of:
causing the data block to be encrypted to pass the sequence of encrypter and decrypter at least once to obtain the encrypted data block, by mapping the encryption result data block to a mapped encryption result data block according to an encryption combining mapping and supplying the encryption result data block to the decryption input of the decrypter.

16. A method for decrypting a data block to be decrypted to a decrypted data block by means of an encrypter having an encryption input and an encryption output for mapping a data block at the encryption input to an encryption result data block at the encryption output according to an encryption mapping, and a decrypter having a decryption input and a decryption output for mapping a data block at the decryption input to a decryption result data block at the decryption output of a decryption mapping which is inverse to the encryption mapping, the method comprising the step of:
causing the data block to be decrypted to pass the sequence of encrypter and decrypter at least once to obtain the decrypted data block, by mapping the encryption result data block to an inversely mapped encryption result data block according to a decryption combining mapping to which the encryption combining mapping is inverse, and supplying the encryption result data block to the decryption input of the decrypter.

17. A computer program having a program code for performing a method for encrypting a data block to be encrypted to an encrypted data block by means of an encrypter having an encryption input and an encryption output for mapping a data block at the encryption input to an encryption result data block at the encryption output according to an encryption mapping, and a decrypter having a decryption input and a decryption output for mapping a data block at the decryption input to a decryption result data block at the decryption output according to a decryption mapping which is inverse to the encryption mapping, the method comprising the step of: causing the data block to be encrypted to pass the sequence of encrypter and decrypter at least once to obtain the encrypted data block, by mapping the encryption result data block to a mapped encryption result data block according to an encryption combining mapping and supplying the mapped encryption result data block to the decryption input of the decrypter, when the computer program runs on a computer.

18. A device for encrypting a data block to be encrypted to an encrypted data block and for decrypting a data block to be decrypted to a decrypted data block, comprising:
an encryption means having an encryption input and an encryption output for mapping a data block at the encryption input to an encryption result data block at the encryption output according to an encryption mapping;
a decryption means having a decryption input and a decryption output for mapping a data block at the decryption input to a decryption result data block at the decryption output according to a decryption mapping which is inverse to the encryption mapping;
an encryption combining means for mapping the encryption result data block to a mapped encryption result data block according to an encryption combining mapping and supplying the mapped encryption result data block to the decryption input of the decryption means;
a decryption combining means for mapping the encryption result data block to an inversely mapped encryption result data block according to a decryption combining mapping to which the encryption combining mapping is inverse and supplying the inversely mapped encryption result data block to the decryption input of the decryption means; and
a controlling means for causing the data block to be encrypted to pass the sequence of encryption means, encryption combining means and decryption means at least once to obtain the encrypted data block and the data block to be decrypted to pass the sequence of encryption means, decryption combining means and decryption means at least once to obtain the decrypted data block.

19. A computer program having a program code for performing a method for decrypting a data block to be decrypted to a decrypted data block by means of an encrypter having an encryption input and an encryption output for mapping a data block at the encryption input to an encryption result data block at the encryption output according to an encryption mapping, and a decrypter having a decryption input and a decryption output for mapping a data block at the decryption input to a decryption result data block at the decryption output of a decryption mapping which is inverse to the encryption mapping, the method comprising the step of: causing the data block to be decrypted to pass the sequence of encrypter and decrypter at least once to obtain the decrypted data block, by mapping the encryption result data block to an inversely mapped encryption result data block according to a decryption combining mapping to which the encryption combining mapping is inverse, and supplying the inversely mapped encryption result data block to the decryption input of the decrypter, when the computer program runs on a computer.
